(19) United States
(12) Patent Application Publication
(10) Pub. No.: US 2011/0200149 A1
(43) Pub. Date: Aug. 18, 2011

(54) PREPROCESSING APPARATUS AND METHOD FOR GROUP-BASED DECODING

(75) Inventors: Euna Choi, Daejon (KR); Dae-Ig Chang, Daejon (KR); Kijoon Lee, Seoul (KR); Habong Jung, Seoul (KR)

(73) Assignee: ELECTRONICS AND TELECOMMUNICATIONS RESEARCH INSTITUTE, DAEJON (KR)

(21) Appl. No.: 12/808,988

(22) PCT Filed: Dec. 16, 2008
(86) PCT No.: PCT/KR2008/007448

§ 371 Date: Jun. 17, 2010

(30) Foreign Application Priority Data
Dec. 17, 2007 (KR) 10-2007-0132301
May 9, 2008 (KR) 10-2008-0043580

(51) Int. Cl. H04L 27/06

(52) U.S. Cl. 375/341

(57) ABSTRACT

Provided are a preprocessing apparatus and a method thereof for group-based decoding. The preprocessing apparatus includes a log likelihood ratio (LLR) calculator for calculating LLRs of received signals, a signal sorter for sorting the received signals based on the calculated LLRs; and a grouping unit for grouping the sorted signals.

### TECHNICAL FIELD

The present invention relates to a preprocessing apparatus and a method thereof for group-based decoding; and, more particularly, to a preprocessing apparatus and for group-based decoding which improves a convergence speed by allocating a different group according to a log likelihood ratio (LLR) of a received signal unlike a conventional technology, which repeats a decoding operation using a group identically allocated for all received signals.

This work was supported by the IT R&D program of MIC/IITA [2007-S-008-01, “Development of 21 GHz Band Satellite Broadcasting Transmission Technology”].

### BACKGROUND ART

Lately, among channel coding schemes, a Low Density Parity Check (LDPC) coding scheme is actually being applied to real systems due to its superior performance. The coding scheme using an LDPC code has an advantage of a fast decoding rate because the LDPC code allows easy parallel decoding unlike a turbo code. Although turbo code has been known as a code with good performance, it is difficult to realize a high speed system with a turbo code because of high implementation complexity.

Since a channel code for designing a broadcasting MODEM has a considerably long frame length, it is difficult to apply it to actual systems despite the general advantages of an LDPC code. As LDPC code has an enormous structure, it is necessary to develop a processing structure that allows high-speed decoding in order to design a channel CODEC supporting diverse code rates.

A ‘Sum-Product’ algorithm and a ‘Min-Sum’ algorithm have been introduced for decoding an LDPC coded signal. Such decoding algorithms repeatedly calculate a log likelihood ratio (LLR) for decoding signal. The LLR denotes a probabilistic reliability degree of a received signal.

The ‘Sum-Product’ algorithm has a high calculation cost because it is required to perform calculation using a mathematical function such as a ‘tan h’ function (real number addition and function evaluation). A table having corresponding function values was used to reduce the calculation cost. On the contrary, the ‘Sum-Product’ algorithm has an advantage of a high decoding performance because of accurate calculation.

Unlike the ‘Sum-Product’ algorithm, the ‘Min-Sum’ algorithm uses approximated equations that are equivalent to the mathematical functions of the ‘Sum-Product’ algorithm, for example, addition, minimum, determination of positive and negative, and multiplication of positive and negative. Therefore, the ‘Min-Sum’ algorithm performs simpler calculation than the ‘Sum-Product’ algorithm. However, the decoding performance deteriorates due to the influence of the approximated equations.

The decoding algorithms for an LDPC code repeatedly decode signals based on propagation of probabilistic information. That is, the ‘Sum-Product’ algorithm or the ‘Min-Sum’ algorithm processes all of columns for all bits of a corresponding coded signal after finishing processing all of rows of the coded signal in one repetition time of decoding.

For example, if a check matrix of an LDPC code to decode is a two way m×n matrix H=[H_{m,n}] where n is an integer larger than 0 smaller than n and m is an integer larger than 0 smaller than M, the decoding algorithm processes rows of all sets (m,n) that satisfies H_{m,n}=1 in an order of m=1, 2, 3, . . . , M. After processing the rows, the decoding algorithm processes columns of all sets (m,n) that satisfies H_{m,n}=1 in an order of n=1, 2, 3, . . . , N.

Accordingly, the decoding algorithm has a problem that decoding latency increases in proportion to the repetition times of a decoding process as the repetition number of a decoding process increases.

In order to overcome the decoding latency problem, a Shuffled Belief Propagation (BP) algorithm was introduced to reduce the repetition number of a decoding operation.

The Shuffled BP algorithm calculates and updates probabilistic information one bit by one bit through processing rows and columns of LDPC coded signals. As a result, the propagation of the probabilistic information is effectively performed, and the convergence is advantageously accelerated.

At first, a repetition time i is set to 1 (i=1), a maximum repetition number is set to Iₘₐₓ, and an initial value z_{m,n}(0) of a log likelihood ration (LLR) is set to Fₙ(z_{m,n}(0):=Fₙ).

Also, a check matrix H of an LDPC code, which is a target matrix, is a two way m×n matrix H=[H_{m,n}] where n is an integer larger than 0 and smaller than N and m is an integer larger than 0 and smaller than M. H_{m,n} denotes an element of a m^{th} row and a n^{th} column of the matrix H.

Then, a row process that calculates Eq. 2 and Eq. 3 is performed with conditions of Eq. 1.

$$\begin{matrix}0 \leq g < G ( g \text{:} Integer , G = N / {N}_{g} ) & Eq . 1 \\ g \cdot {N}_{g} + 1 \leq n \leq ( g + 1 ) \cdot {N}_{g} , m ∈ M ( n ) & \\ {τ}_{m , n}^{( i )} = {\prod }_{{n}^{′} ∈ N ( m ) \backslash n \\ {n}^{′} \leq g \cdot {N}_{g}} tanh ( {z}_{m , {n}^{′}}^{( i )} / 2 ) {\prod }_{{n}^{′} ∈ N ( m ) \backslash n \\ {n}^{′} \geq g \cdot {N}_{g} + 1} tanh ( {z}_{m , {n}^{′}}^{( i - 1 )} / 2 ) & Eq . 2 \\ {ɛ}_{m , n}^{( i )} = log \frac{1 + {τ}_{m , n}^{( i )}}{1 - {τ}_{m , n}^{( i )}} & Eq . 3 \end{matrix}$$

where N(m) and M(n) are subsets of a set[1,N];

N(m) is defined as N(m):={n:Hm,n=1}; and

M(n) is defined as M(n):={m:Hm,n=1}.

That is, N(m) is a set of row indexes having 1 among m rows of a matrix H, and M(n) denotes a set of column indexes having 1 in n columns of a matrix H.

A\a denotes a set obtained by eliminating an element a from a set A. That is, N(m)\n is a set of column indexes with a n^{th} column removed from a set N(m), and M(n)\m is a set of row indexes with a m^{th} row removed from a set M(n).

Z_{m,n′}⁽ⁱ⁾ denotes an LLR updated at an i^{th} repetition, and ε_{m,n}⁽ⁱ⁾ denotes a LLR of an i^{th} repetition that is sent from a check node to a variable node.

Then, a column process that calculates Eq. 4 and Eq. 5 is performed with conditions of Eq. 1.

$$\begin{matrix}{z}_{m , n}^{( i )} = {F}_{n} + {\sum }_{{m}^{′} ∈ M ( n ) \backslash m} {ɛ}_{{m}^{′} \cdot n}^{( i )} & Eq . 4 \\ {z}_{n}^{( i )} = {F}_{n} + {\sum }_{m ∈ M ( n )} {ɛ}_{m , n}^{( i )} & Eq . 5\end{matrix}$$

where z_{m,n}⁽ⁱ⁾ denotes a LLR of an i^{th} repetition that is sent from a check node to a variable node; and

zₙ⁽ⁱ⁾ denotes an after value of the i^{th} repetition.

Then, a hard decision is performed on the after value zₙ⁽ⁱ⁾, and a decoding series is generated at step 1. Eq. 6 shows the decoding series.

w=[wₙ] Eq. 6

where Wₙ denotes elements of a decoding series w from 1 to M.

After the step 1, if Eq. 6 satisfies conditions of Eq. 7, the decoding series of Eq. 6 is outputted. If one of conditions of Eq. 7 is not satisfied, the repetition number i is added by one, and the step 1 is performed again.

Parity Check:OK(H*w=0)

Or

Repetition number is Maximum I=Iₘₐₓ Eq. 7

As described above, the shuffled BP algorithm effectively performs the propagation of probability information by performing the row-process using z_{m,n′}⁽ⁱ⁾ which is an updated LLR at the same i^{th} repetition.

If probability information is calculated and updated one bit by one bit through the row process and the column process of a received signal (Ng=1), it is the shuffled BP algorithm. If probability information is calculated and updated by a unit of predetermined bits (group) through the row process and the column process of a received signal (1<Ng<N), it is a group shuffled BP algorithm.

That is, the group shuffled BP algorithm divides columns of a parity check matrix H used for coding and decoding an LDPC code into several groups and repeatedly performs decoding based on the groups.

In general, the LDPC code can be expressed as a bipartite graph. The bipartite graph expresses the LDPC code with variable nodes, check nodes, and edges connecting the variable nodes and the check nodes.

The group shuffled BP algorithm also performs decoding through updating a probability value between a check node and a variable node in a bipartite graph like LDPC code decoding.

However, the group shuffled BP algorithm characteristically updates the probability value by a predetermined group while updating a probability value from the check node to the variable node.

After a probability value is updated for one group, the updated probability value is used to update a probability value for a next group in order to use further reliable a probability value for a decoding operation, that is, the update operation of the probability value.

That is, a previously updated probability value is not uniformly used in updating a probability value from a check node to a variable node. The previously updated probability value is differently used at each group. The reliability of the probability value between the check node and the variable node is improved using a further reliable probability value for updating a next probability value when the updating of the probability value is repeated. Finally, the performance of a decoder is improved.

Such a group shuffled BP algorithm has an advantage of redwing decoding latency, which is caused by sequentially performing decoding operations, by dividing a variable node into groups and updating messages of variable nodes in each group in parallel.

However, the group shuffled BP algorithm disadvantageously cannot utilize characteristics of a received signal because the group shuffled BP algorithm repeatedly performs decoding operations through groups identically allocated for all of received signals.

That is, the group shuffled BP algorithm has problems of a large computation amount for decoding and slowing down a convergence speed because the group shuffled BP algorithm sequentially groups for all of received signal.

### DISCLOSURE OF INVENTION

### Technical Problem

An embodiment of the present invention is directed to providing a preprocessing apparatus and a method thereof for group based decoding, which improve a convergence speed for group-based decoding by calculating log likelihood ratios (LLR) of received signals and sorting and grouping the received signals based on the calculated LLRs or generating a distribution chart of the received signals and grouping the received signals based on the generated distribution chart.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a preprocessing apparatus for group-based decoding including a log likelihood ratio (LLR) calculator for calculating LLRs of received signals; a signal sorter for sorting the received signals based on the calculated LLRs; and a grouping unit for grouping the sorted signals.

In accordance with another aspect of the present invention, there is provided a preprocessing apparatus for group-based decoding including: an LLR calculator for calculating LLRs of received signals; a distribution generator for generating a distribution chart of the received signals based on the calculated LLRs; and a grouping unit for grouping the received signals using the generated distribution chart.

In accordance with another aspect of the present invention, there is provided a preprocessing method for group-based decoding including: calculating log likelihood ratios (LLR) of received signals; sorting the received signals based on the calculated LLRs; and grouping the sorted signals.

In accordance with another aspect of the present invention, there is provided a preprocessing method for group-based decoding including: calculating LLRs of received signals; generating a distribution chart of the received signals based on the calculated LLRs; and grouping the received signals using the generated distribution chart.

The present invention relates to a group allocation method for improving performance of a grouping shuffled BP algorithm which is a reliability-based decoding method among decoding algorithms of a low density parity check (LDPC) code.

### Advantageous Effects

A preprocessing apparatus and a method thereof can improve a convergence speed for group-based decoding by calculating log likelihood ratios (LLR) of received signals and sorting and grouping the received signals based on the calculated LLRs or generating a distribution chart of the received signals and grouping the received signals based on the generated distribution chart.

### BRIEF DESCRIPTION OF THE DRAWINGS

FIG. 1 is a block view illustrating a group-based decoding apparatus where the present invention is applied to.

FIG. 2 is a block diagram illustrating a preprocessor for group-based decoding in accordance with an embodiment of the present invention.

FIG. 3 is a block diagram illustrating a preprocessor for group-based decoding in accordance with an embodiment of the present invention.

FIG. 4 is a graph showing performance of a group based decoder having a preprocessor according to an embodiment of the present invention.

FIG. 5 is a graph showing performance of a group-based decoder having a pre-processor according to an embodiment of the present invention.

FIG. 6 is a graph showing how a preprocessor sets a section for each group for group-based decoding according to an embodiment of the present invention.

FIG. 7 is a flowchart illustrating a preprocessing method for group-based decoding in accordance with an embodiment of the present invention.

FIG. 8 is a flowchart illustrating a preprocessing method for group-based decoding in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter.

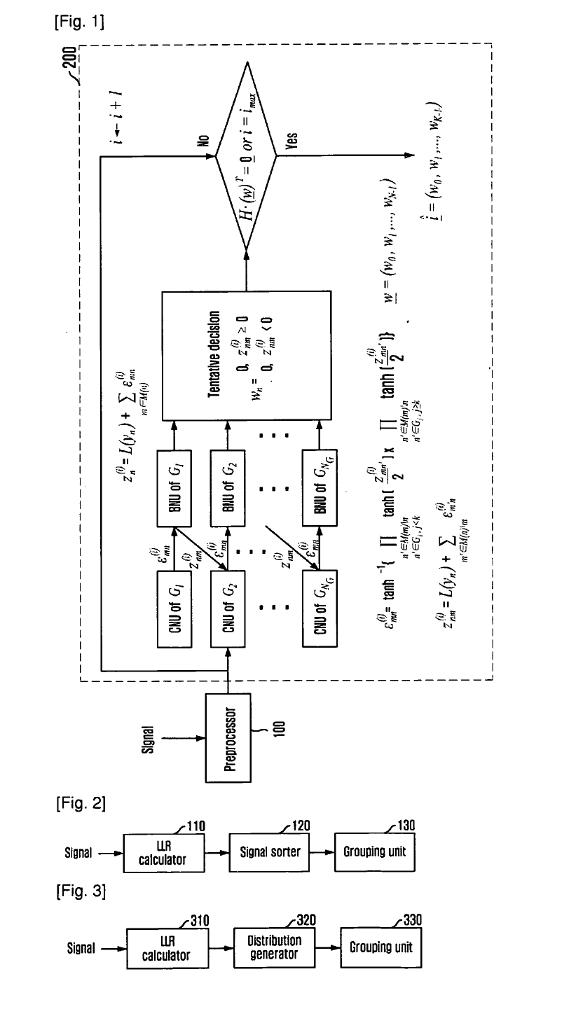

FIG. 1 is a diagram illustrating a group-based decoding apparatus where the present invention is applied to.

As shown in FIG. 1, the group-based decoding apparatus includes a preprocessor 100, and a decoder 200. The preprocessor 100 calculates log likelihood ratios (LLR) of received signals and sorts and groups the received signals based on the calculated LLRs. Or the preprocessor 100 calculates LLRs of received signals, generates a distribution chart of the received signals based on the calculated LLRs, and groups the received signals based on the generated distribution chart. The decoder 200 performs a group-based decoding operation based on the grouping result.

The decoder 200 may use a “Group Shuffled BP” algorithm for decoding.

FIG. 2 is a diagram illustrating a preprocessor for group-based decoding in accordance with an embodiment of the present invention.

As shown in FIG. 2, the preprocessor according to the present embodiment includes a LLR calculator 110, a signal sorter 120, and a grouping unit 130. The LLR calculator 110 calculates LLRs of received signals, the signal sorter 120 sorts the received signals based on the calculated LLRs, and the grouping unit 130 groups the sorted signals.

The signal sorter 120 sorts the received signal based on the calculated LLRs of the received signal in an ascending order and enables the decoder 200 to perform a variable node update operation and a check node update operation sequentially from a group of signals having lowest reliability to a group of signals having highest reliability. Here, the reliability is equivalent to the size of LLR. That is, the reliability of low reliable signals is greatly improved according to the characteristics of a ‘tangent hyperbolic’ function. Therefore, a convergence speed is improved in overall.

The grouping unit 130 groups all of sorted signals from the signal sorter 120 at the same ratio according to a predetermined number of groups. For example, each group includes four signals if 12 signals (a, b, c, l) are sorted according to the LLRs and are grouped into four groups.

FIG. 3 is a diagram illustrating a preprocessor for group-based decoding in accordance with an embodiment of the present invention.

As shown in FIG. 3, the preprocessor according to the present embodiment includes a LLR calculator 130 for calculating a log likelihood ratio (LLR) of a received signal, a distribution generator 320 for generating a distribution chart of received signals based on the calculated LLRs, and a grouping unit 330 for grouping received signals using the generated distribution chart.

The distribution generator 320 generates a distribution chart of received signals according to the LLRs in order to reduce a calculating amount for sorting the received signals based on the LLRs.

The grouping unit 330 groups the received signals of the distribution chart at the same ratio according to a predetermined number of groups.

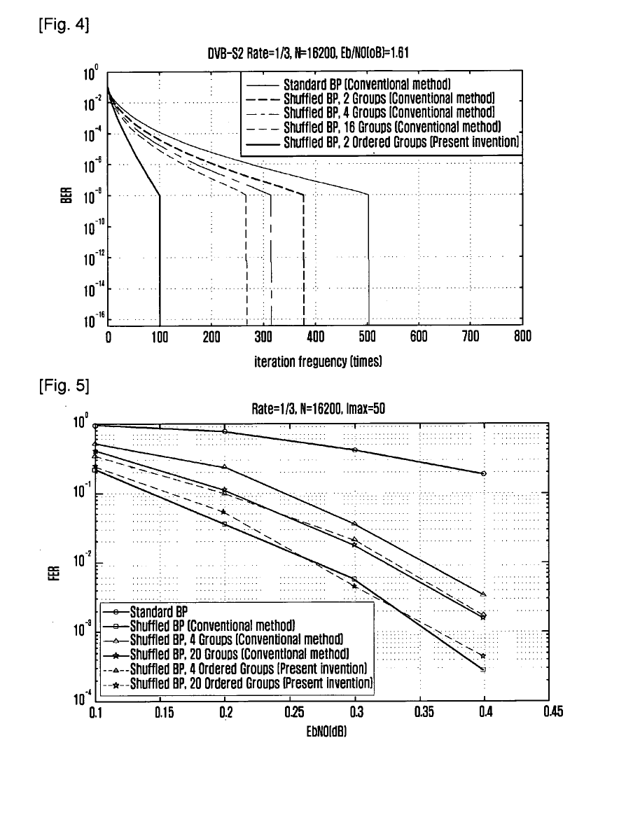

FIG. 4 is a graph showing performance of a group-based decoder having a pre-processor according to an embodiment of the present invention. The graph of FIG. 4 shows a bit error rate (BER) according to iteration times in a ‘density evolution’ step with a code having a length of 16200 (DVB-S2 standard) and r=1/3.

Here, it was assumed that decoding rate correctly converge to a transmitted code when the BER is dropped to below 10⁻⁵.

As shown in FIG. 4, it is converged faster than conventional methods that do not perform the preprocessing operation.

FIG. 5 is a graph showing performance of a group-based decoder having a pre-processor according to an embodiment of the present invention. The graph of FIG. 5 shows a result of simulation using a BPSK modulation scheme in a AWGN channel with a code having a length of 16200 (DVB-S2 standard) and r=1/3.

The graph of FIG. 5 shows that decoding rate converges faster in a group-based decoding operation of the preprocessor according to the present embodiment although the number of groups is smaller than that of the conventional methods. That is, the graph shows that the group-based decoding apparatus having the preprocessor according to the present embodiment can reduce ‘decoding latency’.

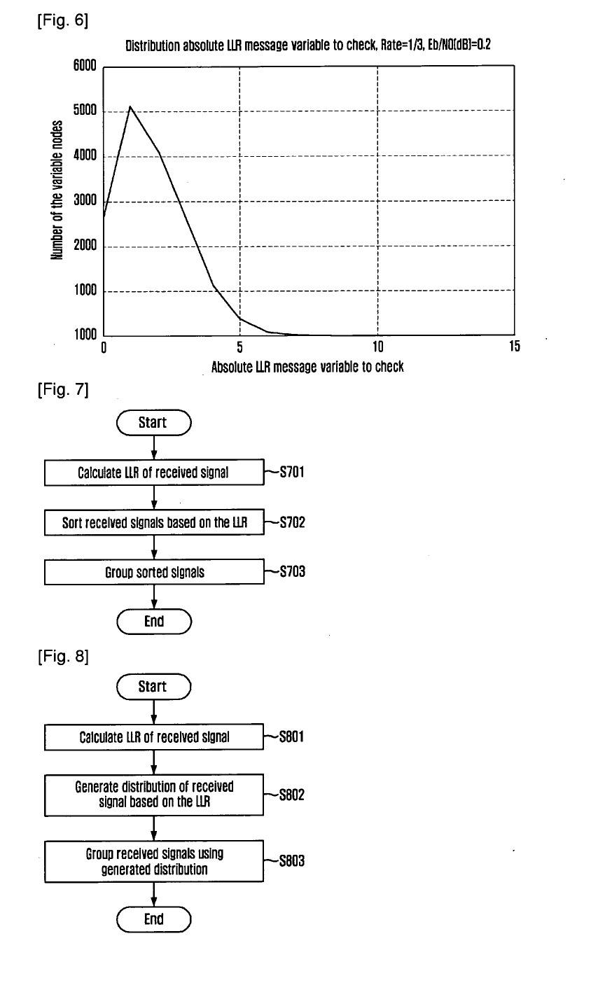

FIG. 6 is a graph showing how a preprocessor sets a section for each group for group-based decoding according to an embodiment of the present invention. The diagram shows distribution of LLRs when a code length is 16200, r=1/3, and N_{G}=4 and shows setting sections of LLR values corresponding to G1, G2, G3, and G4.

FIG. 7 is a flowchart illustrating a preprocessing method for group-based decoding in accordance with an embodiment of the present invention.

At step S701, log likelihood ratios (LLR) of received signals are calculated.

At step S702, the received signals are sorted based on the calculated LLRs. Here, it is preferable to sort the received signals based on the calculated LLRs in an ascending order.

At step S703, the sorted signals are grouped. Here, all of the sorted signals are grouped at the same ratio according to a predetermined number of groups.

FIG. 8 is a flowchart illustrating a preprocessing method for group based decoding in accordance with an embodiment of the present invention.

At step S801, the LLRs of received signals are calculated.

At step S802, a distribution chart of the received signals is generated based on the calculated LLRs.

At step S803, the received signals are grouped using the generated distribution chart. Here, it is preferable to sort the received signals of the distribution chart at the same ratio according to a predetermined number of groups.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to the specific embodiments, it will be apparent to those skilled in the art that various changes and modifications may be made without departing from the spirit and scope of the invention as defined in the following claims.

1. A preprocessing apparatus for group-based decoding, comprising:
a log likelihood ratio (LLR) calculating means for calculating LLRs of received signals;
a signal sorting means for sorting the received signals based on the calculated LLRs; and
a grouping means for grouping the sorted signals.

2. The preprocessing apparatus of claim 1, wherein the signal sorting means sorts the received signals in an ascending order based on the calculated LLRs of the received signals.

3. The preprocessing apparatus of claim 1, wherein the grouping means groups all of the sorted received signals at an identical ratio according to a predetermined number of groups.

4. A preprocessing apparatus for group-based decoding, comprising:
a log likelihood ratio (LLR) calculating means for calculating LLRs of received signals;
a distribution generating means for generating a distribution chart of the received signals based on the calculated LLRs; and
a grouping means for grouping the received signals using the generated distribution chart.

5. The preprocessing apparatus of claim 4, wherein the grouping means groups the received signals of the generated distribution chart at an identical ratio according to a predetermined number of groups.

6. A preprocessing method for group-based decoding, comprising:
calculating log likelihood ratios (LLR) of received signals;
sorting the received signals based on the calculated LLRs; and
grouping the sorted signals.

7. The preprocessing method of claim 6, wherein in said sorting the received signals,
the received signals are sorted in an ascending order based on the calculated LLRs of the received signals.

8. The preprocessing method of claim 6, wherein in said grouping the sorted signals,
all of the sorted received signals are grouped at an identical ratio according to a predetermined number of groups.

9. A preprocessing method for group-based decoding, comprising:
calculating LLRs of received signals;
generating a distribution chart of the received signals based on the calculated LLRs; and
grouping the received signals using the generated distribution chart.

10. The preprocessing method of claim 9, wherein in said grouping the received signals, the received signals of the generated distribution chart are grouped at an identical ratio according to a predetermined number of groups.
